(19) United States
(12) Patent Application Publication
(10) Pub. No.: US 2025/0209384 A1
(43) Pub. Date: Jun. 26, 2025

(54) AUTOMATICALLY PREDICTING DEVICE LABELING INFORMATION USING ARTIFICIAL INTELLIGENCE TECHNIQUES

(71) Applicant: Dell Products L.P., Round Rock, TX (US)

(72) Inventors: Srikanth Vissapragada, Hyderabad (IN); Bijan Kumar Mohanty, Austin, TX (US); Hung T. Dinh, Austin, TX (US)

(21) Appl. No.: 18/393,987

(22) Filed: Dec. 22, 2023

(51) Int. Cl. G06N 20/20; G06N 20/10

(52) U.S. Cl. CPC G06N 20/20; G06N 20/10

(57) ABSTRACT

Methods, apparatus, and processor-readable storage media for automatically predicting device labeling information using artificial intelligence techniques are provided herein. An example computer-implemented method includes obtaining data pertaining to a request from a user for at least one device; predicting labeling information for the at least one device by processing at least a portion of the obtained data using one or more artificial intelligence techniques; generating, based at least in part on the predicted labeling information, at least one image of at least one label to be applied to the at least one device; and performing one or more automated actions based at least in part on the at least one generated image of the at least one label.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Many enterprises and other organizations provide labeling of products and/or devices, and such labels often include default and/or limited information in a fixed format. However, customers and other users increasingly seek customized information on labels and/or particular placement of labels on certain products and/or devices. Conventional label management techniques, however, typically require resource-intensive manual efforts which are error-prone and sources of delays that can affect other systems and processes.

### SUMMARY

Illustrative embodiments of the disclosure provide techniques for automatically predicting device labeling information using artificial intelligence techniques.

An exemplary computer-implemented method includes obtaining data pertaining to a request from a user for at least one device, and predicting labeling information for the at least one device by processing at least a portion of the obtained data using one or more artificial intelligence techniques. Additionally, the method also includes generating, based at least in part on the predicted labeling information, at least one image of at least one label to be applied to the at least one device, and performing one or more automated actions based at least in part on the at least one generated image of the at least one label.

Illustrative embodiments can provide significant advantages relative to conventional label management techniques. For example, problems associated with resource-intensive and error-prone techniques are overcome in one or more embodiments through automatically predicting and generating device label images and corresponding metadata using one or more artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically predicting device labeling information using artificial intelligence techniques in an illustrative embodiment.

FIG. 2 shows example device label templates in an illustrative embodiment.

FIG. 3 shows an example workflow for generating a custom device label in an illustrative embodiment.

FIG. 4 shows an example system architecture in an illustrative embodiment.

FIG. 5 shows an example generated device label image in an illustrative embodiment.

FIG. 6 shows example pseudocode for implementing data preprocessing techniques in an illustrative embodiment.

FIG. 7 shows example pseudocode for encoding categorical values into numerical values in an illustrative embodiment.

FIG. 8 shows example pseudocode for splitting the dataset into training and testing datasets in an illustrative embodiment.

FIG. 9 shows example pseudocode for implementing an extreme gradient boosting classifier and a multi-output classifier in an illustrative embodiment.

FIG. 10 shows example pseudocode for training a device label prediction model in an illustrative embodiment.

FIG. 11 is a flow diagram of a process for automatically predicting device labeling information using artificial intelligence techniques in an illustrative embodiment.

FIGS. 12 and 13 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

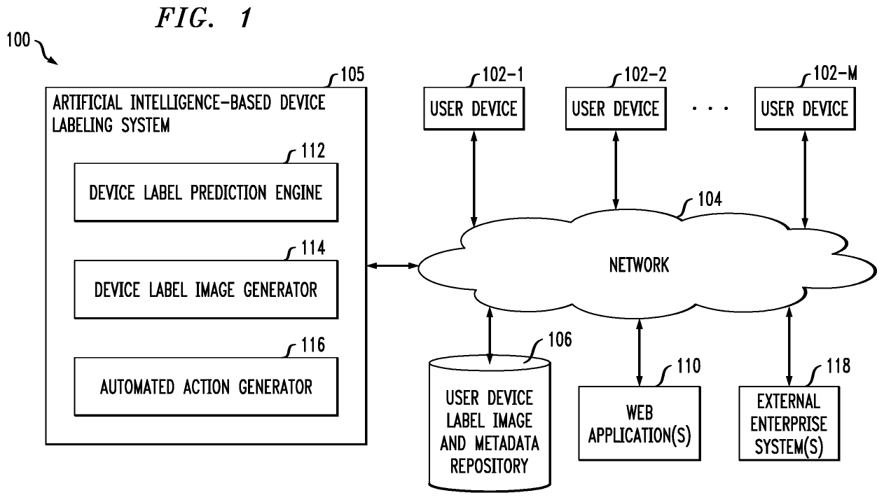

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is artificial intelligence-based device labeling system 105, one or more web applications 110 (e.g., one or more e-commerce applications, one or more order management applications, etc.) and one or more external enterprise systems 118 (e.g., one or more shipping systems, one or more logistics systems, one or more inventory systems, etc.) which can interact with artificial intelligence-based device labeling system 105 in connection with generating and/or implemented device labels.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the artificial intelligence-based device labeling system 105 can have an associated user device label image and metadata repository 106 configured to store data pertaining to previous and/or historical device labels associated with various uses and various devices, wherein such data can include user data, image data, and various forms of label metadata, such as further detailed herein.

The user device label image and metadata repository 106 in the present embodiment is implemented using one or more storage systems associated with the artificial intelligence-based device labeling system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the artificial intelligence-based device labeling system 105 are one or more input-output devices, which illustratively comprise keyboards, displays or other types of input-output devices in any combination. Such input-output devices can be used, for example, to support one or more user interfaces to the artificial intelligence-based device labeling system 105, as well as to support communication between the artificial intelligence-based device labeling system 105 and other related systems and devices not explicitly shown.

Additionally, the artificial intelligence-based device labeling system 105 in the FIG. 1 embodiment is assumed to be implemented using at least one processing device. Each such processing device generally comprises at least one processor and an associated memory, and implements one or more functional modules for controlling certain features of the artificial intelligence-based device labeling system 105.

More particularly, the artificial intelligence-based device labeling system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the artificial intelligence-based device labeling system 105 to communicate over the network 104 with the user devices 102, and illustratively comprises one or more conventional transceivers.

The artificial intelligence-based device labeling system 105 further comprises device label prediction engine 112, device label image generator 114, and automated action generator 116.

It is to be appreciated that this particular arrangement of elements 112, 114 and 116 illustrated in the artificial intelligence-based device labeling system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automatically predicting device labeling information using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of artificial intelligence-based device labeling system 105, user device label image and metadata repository 106, and web application(s) 110 can be on and/or part of the same processing platform.

An exemplary process utilizing elements 112, 114 and 116 of an example artificial intelligence-based device labeling system 105 in computer network 100 will be described in more detail with reference to the flow diagram of FIG. 11.

Accordingly, at least one embodiment includes automatically predicting device labeling information using artificial intelligence techniques. As used herein, device labeling refers to applying a label to a given device itself and/or to an element associated with the device such as, for example, packaging of the device. Such an embodiment includes generating and/or implementing an intelligent, predictive device label prediction framework with dynamic templates and metadata for minimizing quality issues, improving user experiences, etc. In such an embodiment, the framework utilizes dynamic label templates (also referred to herein as label images) and leverages one or more machine learning algorithms to select the image template and the metadata needed to print a given label image.

In at least one embodiment, the one or more machine learning algorithms can be trained using historical label image data selected and/or used by various users, as well as using multi-dimensional data including, e.g., user name(s), location information, business domain information, product model information, product category information, etc. Once trained, the one or more machine learning algorithms can process input data (e.g., data pertaining to a given product, device, and/or other physical asset that needs to be packaged and/or shipped) and predict and/or recommend one or more images (e.g., the most likely image(s)) that the corresponding user will select based at least in part on similar images chosen by similar users. Additionally, such an embodiment can also include predicting and/or recommending metadata in conjunction with the one or more images. Such metadata can include, for example, information about the label image such as whether barcode or text is used for a given line, the type of entities used in various lines, whether a given entity is a product identifier, a serial number, an asset tag, a purchase order (PO) number, etc. As used herein, an entity refers to metadata that a given user wants to see on one or more lines of a label and/or label image, and example entities can include, e.g., serial number, PO order number, etc., and the type of entity can include, e.g., text format, barcode format, etc.

In accordance with one or more embodiments, users can request to customize one or more device labels as per one or more user preferences and/or requirements. As further detailed herein, a device label comprises a set of information describing the device (e.g., a hardware product and/or component(s) thereof) which is to be attached to the device and/or packaging thereof at one or more specific locations (e.g., for access to read and/or scan). A device label often conveys important details to users (e.g., customers and/or other end-users) about the corresponding device.

In one or more embodiments, device labels can include item-level labels and/or packaging labels. Item-level labels can be attached, for example, to and/or on each individual item associated with a given device with information such as, e.g., a service tag, a help desk number, etc. By way merely of example, an enterprise may instruct that every laptop will have a label attached on the bottom panel of the laptop, wherein the label includes a service tag and one or more other items of relevant information. Packaging labels can include, for example, shipping and/or billing information, information identifying the device(s) and/or component(s) thereof inside the package, etc. For both item-level labels and packaging labels, data and/or information contained therein can be printed in a variety of formats (e.g., plain text, barcode, quick-response (QR) code, etc.) and in a variety of sizes.

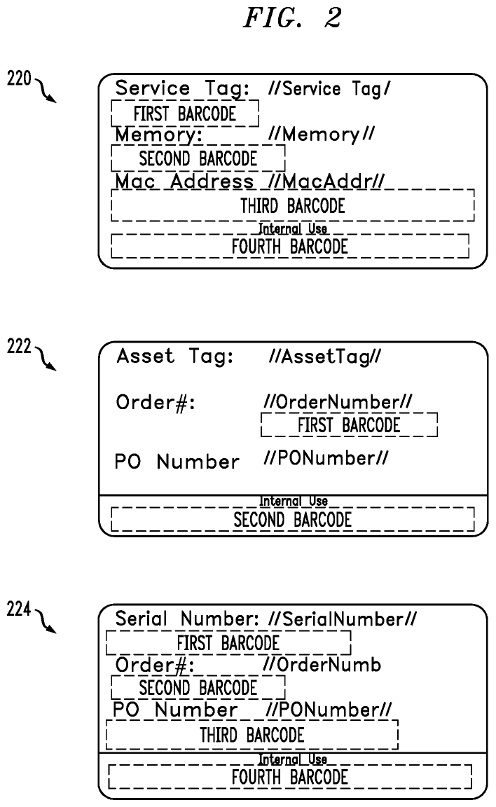

FIG. 2 shows example device label templates in an illustrative embodiment. By way of illustration, FIG. 2 depicts example device label templates 220, 222, and 224, each of which includes printed metadata pertaining to the device associated therewith. By way merely of example, example device label template 220 includes metadata comprising a service tag, memory information, and a media access control (MAC) address. Example device label template 222 includes metadata comprising an asset tag, an order number, and a PO number. Further example device label template 224 includes metadata comprising a serial number, an order number, and a PO number. Additionally, in example device label templates 220, 222, and 224, the content between the “//” symbols will only vary by order in situations wherein the format of the label is fixed and fields between the “//” symbols are fixed. In such an embodiment, the values and/or other content between “//” symbols are filled from an order and/or other transaction related to the device corresponding to the label(s). Further, in one or more embodiments, every label can include particular information such as, e.g., a unique part number, one or more barcodes (e.g., one or more barcode information files such as “bartender files” (.btw)), a preview image, manufacturing instructions (MIs), etc. In such an embodiment, a .btw file is merely an example of what is more generally referred to as a barcode information file, and other types of barcode information files can be used in other embodiments.

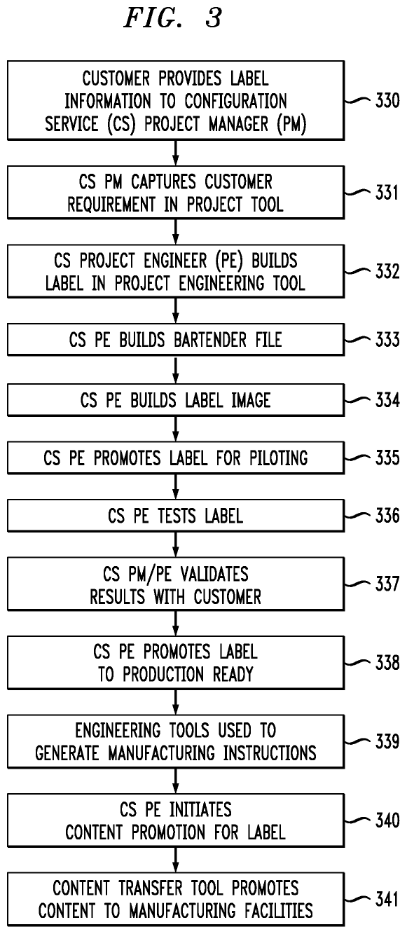

FIG. 3 shows an example workflow for generating a custom device label in an illustrative embodiment. As detailed herein, one or more embodiments include overcoming various label management challenges by predicting and/or recommending dynamic device labels for particular users. By leveraging one or more machine learning models and training such models using historical label template data and relevant metadata, such an embodiment can include predicting which label template(s) and metadata are most appropriate for a given user, outputting such a prediction to the given user as a recommendation, wherein the user can then either accept the recommendation or select a different template and metadata, which then can be fed into the one or more machine learning models as training data for future recommendations.

As depicted in the example workflow illustrated in FIG. 3, step 330 includes a user, such as a customer, providing label information to a configuration service (CS) project manager (PM). In step 331, the CS PM captures one or more customer requirements, provided as part of step 330, in a project tool (e.g., a tool used to manage a configuration services project while working with the given user, wherein user specifications are created and/or modified). In step 332, a CS project engineer (PE) generates and/or builds a label in the project tool as per the one or more customer requirements, and in step 333, the CS PE generates and/or builds a bartender file, as per the one or more customer requirements, to be used on the label.

In step 334, the CS PE generates and/or builds a label image, as per the one or more customer requirements, based at least in part on the outputs of step 332 and step 333. In step 335, the CS PE promotes the label for piloting, and in step 336, the CS PE tests the label. With respect to promoting the label for piloting in step 335, when a CS is delivered, users can often, for example, apply that CS to a large number of devices (e.g., a user wanting to put a custom image and a specific type of label on particular devices, etc.). After these configuration items are designed and engineered, the configuration items are applied to a pilot system for user approval, and once the configuration items are approved, the configuration items are applied to all of the devices designated by the user (e.g., all of the devices that the user is purchasing). In step 337, the CS PM and/or the CS PE validates the test results with the customer, and in step 338, the CS PE promotes the label to a status of production ready.

In step 339, engineering tools (e.g., tools to create images and other configuration services items) are used to generate MIs, and in step 340, the CS PE initiates content promotion (e.g., .btw files, MIs, label images, etc.) for the label. By way of example, contents can include an operating system image and label artifacts such as label metadata, label placement location(s), etc., which are sent to manufacturing facilities for applying these configuration services once the given device is assembled. Further, in step 341, a content transfer tool promotes content to one or more manufacturing facilities (e.g., globally) for a given enterprise.

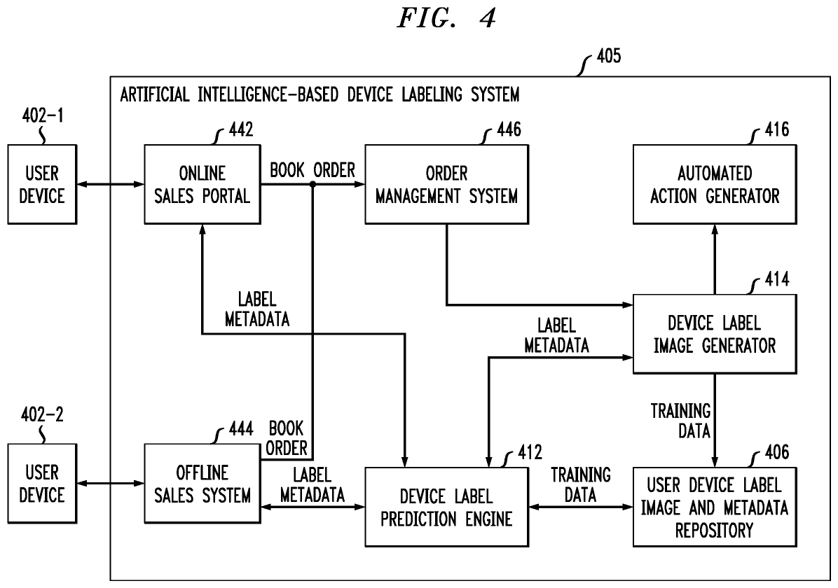

FIG. 4 shows an example system architecture in an illustrative embodiment. By way of illustration, FIG. 4 depicts user devices 402-1 and 402-2 interacting with artificial intelligence-based device labeling system 405. Specifically, user device 402-1 exchanges information pertaining to at least one device order with online sales portal 442, and user device 402-2 exchanges information pertaining to at least one device order with offline sales system 444 (e.g., via telephone). Additionally, online sales portal 442 and offline sales system 444 passes order information to order management system 446, which produces an order which is forwarded to device label image generator 414, which will assemble the data with the corresponding values, as further detailed below.

As also depicted in FIG. 4, device label prediction engine 412 sends label image metadata and corresponding types (e.g., in the form of various templates such as those depicted, for example, in FIG. 2) to user devices 402-1 and 402-2 (based, e.g., on corresponding user profiles) via online sales portal 442 and offline sales system 444, respectively. Additionally, device label prediction engine 412 sends label image metadata and corresponding types (e.g., in the form of a given template selected by one of the user devices) to the device label image generator 414, which then extracts the appropriate information from the order information (provided by order management system 446) and processes all relevant data (e.g., entity names, types and values) to generate the label image.

More specifically, in one or more embodiments, upon receipt of an indication of acceptance of the at least one prediction (e.g., acceptance of one of the provided templates) by user device 402-1 and/or 402-2, device label prediction engine 412 provides the predicted label metadata and/or formatting information to device label image generator 414.

The device label image generator 414 generates at least one device label image based at least in part on the input(s) provided by device label prediction engine 412, and provides the at least one device label image to automated action generator 416. Based at least in part on the at least one device label image, automated action generator 416 can automatically initiate the printing of at least one device image (e.g., in connection with manufacturing facilities), output the at least one device label image to one or more of user device 402-1 and user device 402-2 for approval, etc. Additionally, device label image generator 414 provides the at least one device label image to user device label image and metadata repository 406, wherein at least a portion of the data stored therein is used to train and/or re-train device label prediction engine 412.

In one or more embodiments, such as depicted in FIG. 4, the device label prediction engine 412 is trained to predict label image metadata including, for example, entity name and/or entity-related information (e.g., a service tag, an order number, a PO number, etc.), entity type (e.g., barcode, text) by leveraging one or more artificial intelligence techniques such as an extreme gradient boosting classifier that is trained from historical label image metadata stored in the user device label image and metadata repository 406.

Accordingly, at least one embodiment builds and/or manages a dynamic template repository (e.g., user device label image and metadata repository 406) of historical device label orders for one or more users. This repository acts as a foundational data store for building and/or implementing an intelligent label recommendation engine (e.g., device label prediction engine 412). Training one or more artificial intelligence algorithms using at least a portion of the templates and metadata from the repository, one or more embodiments can include predicting the most appropriate label template and metadata for a given device and/or a given user. Using multi-dimensional features of the historical device label data from production (as managed in the repository), such an embodiment can include using an ensemble boosting-based multi-output classifier to predict the template (e.g., both the entity name(s) and entity type(s)) that matches the feature(s) in question, including, for example, user class (e.g., consumer versus commercial), user domain (e.g., high-tech, finance, manufacturing, etc.), product, product class (e.g., server, storage, laptop, desktop, etc.), etc.

As such, one or more embodiments include generating and/or implementing an intelligent, dynamic template for a given device label image, wherein the template contains an entity name and an entity type (e.g., for each line in the image). The entity type can be important, for example, because the display type of the entity can vary from one image to another. For example, a customer name, which can exceed a certain letter amount, can be difficult to print in one line, so a bar code might be more suitable. The template can work as an abstracted template that can be converted into multiple types based on different user needs.

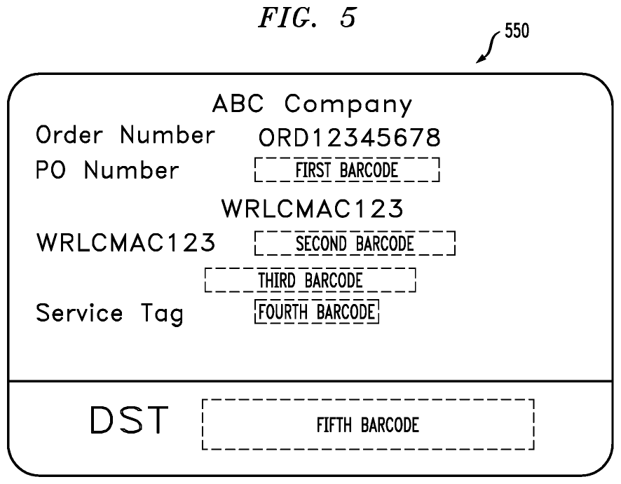

Once a template is created for a user, template values, e.g., the entity name and the entity type, are stored and used for printing the final image with the real data. For example, in an illustrative template for ABC company, the entity name and types can include the following: <Order Number> <Text>; <PO Number> <Bar Code>; and <Service Tag> <Bar Code>. With the actual entity values derived from the order information (e.g., the order number), the template can be passed to the appropriate system to generate the device label image, such as shown in FIG. 5, which depicts an example generated device label image 550 in an illustrative embodiment.

Accordingly, as detailed herein, at least one embodiment includes generating a smart recommendation of a device label image (including, e.g., the entity name and the entity type) based at least in part on historical image data of various users. Such an embodiment includes using a deep neural network-based multi-output and/or multi-target classifier that can predict the entities and their type(s) to be printed in connection with given device labels. The output of the classifier can be fed, for example, to at least one printing system along with the corresponding order data that contains the actual values of each entity. By way of example, for four types of entities shown in a label image, there will be four target values and four types for each target shown in the learning data processed by the classifier.

Referring again to FIG. 4, one or more embodiments include building and/or implementing at least one user device label image and metadata repository 406, which stores metadata associated with device label images for one or more users, wherein such metadata can include user details such as user name, user domain, product model, product category, geographic information, and/or various targets and/or label formatting information that can include entity names and entity types to be used in the label image. Such metadata can be used to train device label prediction engine 412 to predict the entities and metadata of a given device label image for a given customer.

As detailed herein, device label prediction engine 412 is responsible for predicting the number of entities, the names of such entities, and the type of such entities for at least one given device label image. Such predicting is achieved, in one or more embodiments, by utilizing existing device label metadata for the given user as a training dataset, and leveraging at least one ensemble boosting, multi-output classification algorithm (e.g., XGBoost) as a classifier (e.g., to predict multiple types of entities and information related thereto).

In at least one embodiment, device label prediction engine 412 leverages at least one supervised learning mechanism and trains a model using historical user device label image metadata along with target values which can include entity names and entity types used in creating the label image. As noted above, device label prediction engine 412 can include implementing an ensemble boosting approach using at least one gradient boosting classifier algorithm. Additionally or alternatively, one or more embodiments can include using one or more shallow learning algorithms such as, e.g., ensemble decision tree bagging and boosting, at least one k-nearest neighbors (K-NN) algorithm, and/or one or more support vector machines (SVMs).

As used herein in connection with one or more embodiments, gradient boosting is an ensemble boosting algorithm that utilizes a multitude of weak decision tree-based models to build one strong(er) model with enhanced prediction accuracy. As an ensemble approach, gradient boosting uses a group of weak models, and as a boosting approach, gradient boosting iteratively learns from each weak model to build the strong(er) model. This is a sequential approach of learning and building the strong(er) model, and is capable of various types of machine learning activities including, e.g., regression, classification, ranking, and recommendation. Also, gradient boosting is an iterative functional gradient algorithm, i.e., an algorithm which minimizes a loss function by iteratively choosing a function that points towards the negative gradient.

In a gradient boosting algorithm such as used in one or more embodiments, each predictor (e.g., device label entity) attempts to improve on its predecessor by reducing the error. But, instead of fitting the predictor on the data on each iteration, the gradient boosting algorithm fits a new predictor to the residual error(s) made by the previous predictor. The steps of such an algorithm can include the following.

To make an initial prediction on data, the algorithm will determine the log of the odds of a target variable (e.g., an entity name or an entity type). Such a determination can include, for example, calculating the number of one type of value (e.g., a barcode entity type) divided by the number of another type of value (e.g., a text entity type). For instance, in a dataset of 200,000 user assets, if 120,000 of the assets have an entity type marked as “barcode” and 80,000 of the assets have an entity type marked as “text,” then the log(odds)=log(120,000/80,000). This can then serve as the base estimator, which will be used for the initial prediction.

The log(odds) is then converted into a probability value by using a logistic function to make predictions. The formula to convert the log(odds) to a probability can be seen below in Equation (1):

$$e * log ( odds ) \div ( 1 + e * log ( odds ) ) \qquad ( 1 )$$

For every observation of the training set, the gradient boosting algorithm calculates the error or residual for that observation or instance, akin to the difference between the observed value and the predicted value. Once the residuals are calculated, a new decision tree is built that attempts to predict the errors or residuals that were previously calculated. For a gradient boost for classification, the formula for transformation can be seen below in Equation (2):

$$\frac{\sum {Residual}_{i}}{\sum [ Previous {Probability}_{i} \times ( 1 - Previous {Probability}_{i} ) ]} \qquad ( 2 )$$

wherein Σ indicates a sum of, and the “Previous Probability” refers to the previously calculated probability computed earlier from the log(odds) as described above.

Additionally, the gradient boosting algorithm makes a new prediction by first getting the log(odds) prediction for a given observation or instance in the training set, and then converting that prediction into a probability. The formula for making such a prediction can be seen below in Equation (3):

$$base\_log ( odds ) + learning\_rate * predicted residual value ) \qquad ( 3 )$$

wherein the learning_rate is a model hyperparameter which can be tuned to scale each tree's contribution, sacrificing bias for improved variance.

Additionally or alternatively, one or more embodiments include leveraging an extreme gradient boosting algorithm, which is an extension algorithm to a standard gradient boosting algorithm and capable of enhancing performance and accuracy.

As detailed herein, one or more embodiments include predicting multiple items (e.g., various label image entity names and entity types) at approximately the same time, and accordingly, such an embodiment includes using a multi-output classifier model. By way of example, such an embodiment can include implementing a ScikitLearn library which provides a multi-output classifier function that can be used to in conjunction with the actual gradient boosting and/or extreme gradient boosting model to enable multi-output classification.

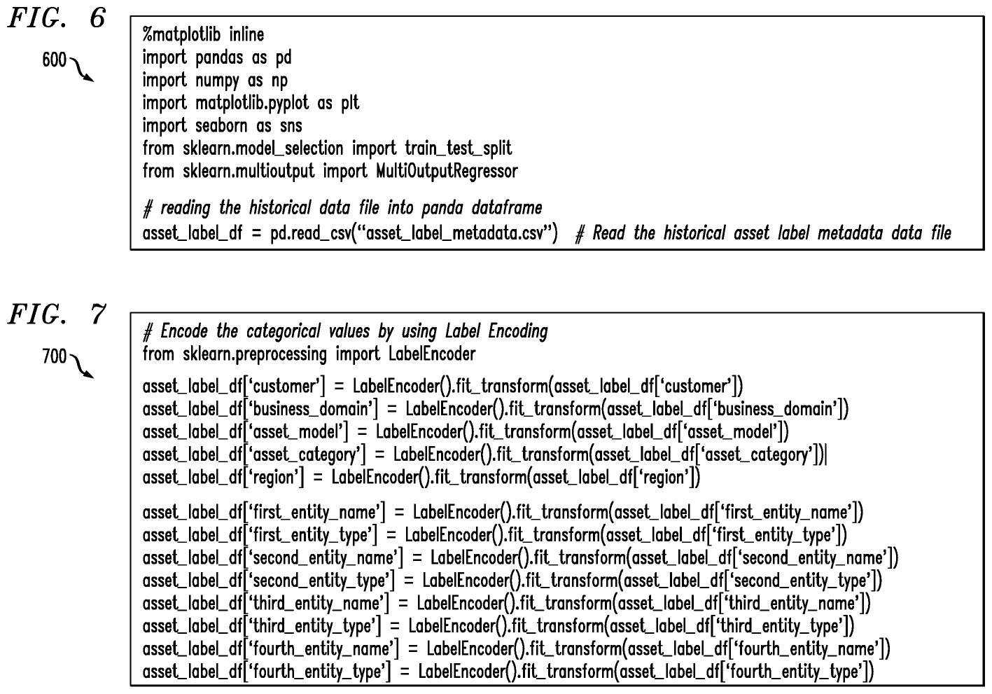

The implementation of an intelligent label recommendation engine (e.g., device label prediction engine 412) can be achieved, as illustrated, for example, in FIG. 6 through FIG. 10, by using Keras with a Tensorflow backend, Python language, and Pandas, Numpy and ScikitLearn libraries.

FIG. 6 shows example pseudocode for implementing data preprocessing techniques in an illustrative embodiment. In this embodiment, example pseudocode 600 is executed by or under the control of at least one processing system and/or device. For example, the example pseudocode 600 may be viewed as comprising a portion of a software implementation of at least part of artificial intelligence-based device labeling system 105 of the FIG. 1 embodiment.

The example pseudocode 600 illustrates importing multiple libraries, reading a dataset of historical asset label information, and generating a Pandas dataframe. The dataframe can contain columns including one or more independent variables and one or more dependent or target variable columns (e.g., device label entity names and device label entity types). Further, in one or more embodiments, such data preprocessing can include handling any null or missing values in the columns. In such an embodiment, null or missing values in numerical columns can be replaced by the median value of that column.

The data preprocessing can also include creating one or more univariate and/or bivariate plots of at least a portion of the columns, whereby the importance and/or influence of each column can be learned and/or understood. Columns that have no or limited role and/or influence on the actual prediction (i.e., the target variable) can be dropped and/or removed.

It is to be appreciated that this particular example pseudocode shows just one example implementation of data preprocessing techniques, and alternative implementations can be used in other embodiments.

FIG. 7 shows example pseudocode for encoding categorical values into numerical values in an illustrative embodiment. In this embodiment, example pseudocode 700 is executed by or under the control of at least one processing system and/or device. For example, the example pseudocode 700 may be viewed as comprising a portion of a software implementation of at least part of artificial intelligence-based device labeling system 105 of the FIG. 1 embodiment.

The example pseudocode 700 illustrates encoding categorical values into numerical values, as machine learning models deal with numerical values. As such, any textual categorical values in the columns must be encoded into numerical values. For instance, as illustrated in example pseudocode 700, categorical values such as, e.g., customer, business domain, asset model, asset category, region, etc. are encoded by using LabelEncoder from a ScikitLearn library.

It is to be appreciated that this particular example pseudocode shows just one example implementation of encoding categorical values into numerical values, and alternative implementations can be used in other embodiments.

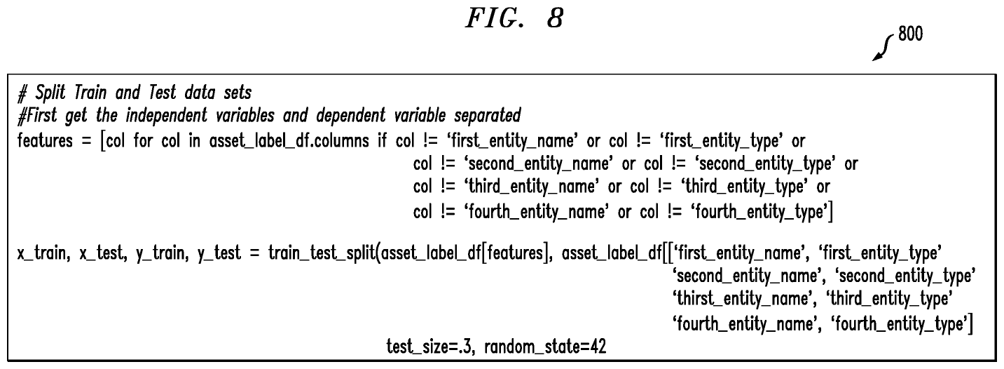

FIG. 8 shows example pseudocode for splitting the dataset into training and testing datasets in an illustrative embodiment. In this embodiment, example pseudocode 800 is executed by or under the control of at least one processing system and/or device. For example, the example pseudocode 800 may be viewed as comprising a portion of a software implementation of at least part of artificial intelligence-based device labeling system 105 of the FIG. 1 embodiment.

The example pseudocode 800 illustrates splitting the entire dataset is split into training and testing datasets using the train_test_split function of a ScikitLearn library. In at least one embodiment, the splitting can include splitting 70% of the dataset into the training dataset and the remaining 30% of the dataset into the testing dataset. Also, as depicted in example pseudocode 800, because this is a use case of multi-target prediction, it is important to separate all of the target variables from the dataset.

It is to be appreciated that this particular example pseudocode shows just one example implementation of splitting the dataset into training and testing datasets, and alternative implementations can be used in other embodiments.

Accordingly, subsequent to splitting the dataset and creating training and testing datasets, at least one embodiment includes creating one or more models using one or more algorithms of the ScikitLearn library. In an example embodiment, as further detailed below and herein, which includes utilizing an extreme gradient boosting algorithm (which is not native to ScikitLearn), the extreme gradient boosting algorithm needs to be installed using a pip install function.

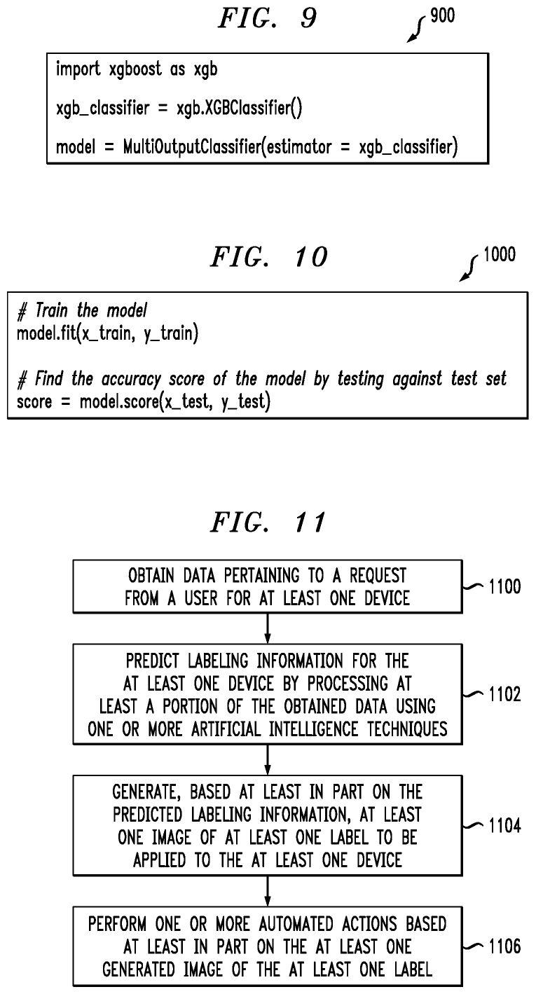

FIG. 9 shows example pseudocode for implementing an extreme gradient boosting classifier and a multi-output classifier in an illustrative embodiment. In this embodiment, example pseudocode 900 is executed by or under the control of at least one processing system and/or device. For example, the example pseudocode 900 may be viewed as comprising a portion of a software implementation of at least part of artificial intelligence-based device labeling system 105 of the FIG. 1 embodiment.

The example pseudocode 900 illustrates creating and/or importing an extreme gradient boosting classifier as well as a MultiOutputClassifier from the ScikitLearn library. As depicted in example pseudocode 900, the final model is created by passing the extreme gradient boosting classifier as input to the MultiOutputClassifier function as an estimator.

It is to be appreciated that this particular example pseudocode shows just one example implementation of an extreme gradient boosting classifier and a multi-output classifier, and alternative implementations can be used in other embodiments.

FIG. 10 shows example pseudocode for training a device label prediction model in an illustrative embodiment. In this embodiment, example pseudocode 1000 is executed by or under the control of at least one processing system and/or device. For example, the example pseudocode 1000 may be viewed as comprising a portion of a software implementation of at least part of artificial intelligence-based device labeling system 105 of the FIG. 1 embodiment.

The example pseudocode 1000 illustrates training the model, such as created in FIG. 9 via example pseudocode 900, by passing the training dataset, such as generated in FIG. 8 via example pseudocode 800, to the fit( ) function, obtaining the corresponding accuracy score by calling the score( ) function and passing the testing dataset, such as also generated in FIG. 8 via example pseudocode 800.

It is to be appreciated that this particular example pseudocode shows just one example implementation of training a device label prediction model, and alternative implementations can be used in other embodiments.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions based at least in part on order data and historical user device label information, and such recommendations and/or predictions can be used to initiate one or more automated actions (e.g., automatically printing a device label, automatically outputting such recommendations and/or predictions to at least one corresponding user for approval, automatically training the artificial intelligence techniques used to make the recommendations and/or predictions, etc.).

FIG. 11 is a flow diagram of a process for automatically predicting device labeling information using artificial intelligence techniques in an illustrative embodiment. It is to be understood that this particular process is only an example, and additional or alternative processes can be carried out in other embodiments.

In this embodiment, the process includes steps 1100 through 1106. These steps are assumed to be performed by the artificial intelligence-based device labeling system 105 utilizing elements 112, 114 and 116.

Step 1100 includes obtaining data pertaining to a request from a user for at least one device. In at least one embodiment, obtaining data pertaining to the request from the user for the at least one device includes obtaining information pertaining to at least one of an order by the user for the at least one device and shipping instructions for the at least one device to the user.

Step 1102 includes predicting labeling information for the at least one device by processing at least a portion of the obtained data using one or more artificial intelligence techniques. In one or more embodiments, processing at least a portion of the obtained data using one or more artificial intelligence techniques includes processing the at least a portion of the obtained data using at least one ensemble boosting-based multi-output classifier. In such an embodiment, processing the at least a portion of the obtained data using at least one ensemble boosting-based multi-output classifier can include using one or more of at least one gradient boosting classifier and at least one extreme gradient boosting classifier. Additionally or alternatively, processing at least a portion of the obtained data using one or more artificial intelligence techniques can include processing the at least a portion of the obtained data using one or more shallow learning algorithms comprising one or more ensemble decision tree bagging and boosting techniques, at least one K-NN algorithm, and/or one or more SVMs.

Step 1104 includes generating, based at least in part on the predicted labeling information, at least one image of at least one label to be applied to the at least one device. In at least one embodiment, generating the at least one image of the at least one label includes inserting one or more items of content, corresponding to at least a portion of the predicted labeling information, into one or more portions of at least one device label template selected in accordance with at least one of the predicted labeling information and the obtained data. Additionally or alternatively, generating the at least one image of at least one label to be applied to the at least one device can include generating the at least one image of at least one label to be applied to at least one of a device component of the device and a packaging component associated with the device.

Step 1106 includes performing one or more automated actions based at least in part on the at least one generated image of the at least one label. In one or more embodiments, performing one or more automated actions includes automatically generating at least one device label, in accordance with the at least one generated image, to be applied to the at least one device in connection with the request from the user. In such an embodiment, generating at least one device label can include generating the at least one device label upon obtaining approval by the user of the at least one generated image. Additionally or alternatively, performing one or more automated actions can include automatically outputting, to the user for approval, one or more of the predicted labeling information and the at least one generated image. Further, in at least one embodiment, performing one or more automated actions can include automatically training at least a portion of the one or more artificial intelligence techniques using at least the at least one generated image of the at least one label.

The techniques depicted in FIG. 11 can also include training the one or more artificial intelligence techniques using multi-dimensional features derived from historical device labeling information across multiple users and multiple devices.

Accordingly, the particular processing operations and other functionality described in conjunction with the flow diagram of FIG. 11 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically predict device labeling information using artificial intelligence techniques. These and other embodiments can effectively overcome problems associated with resource-intensive and error-prone techniques.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

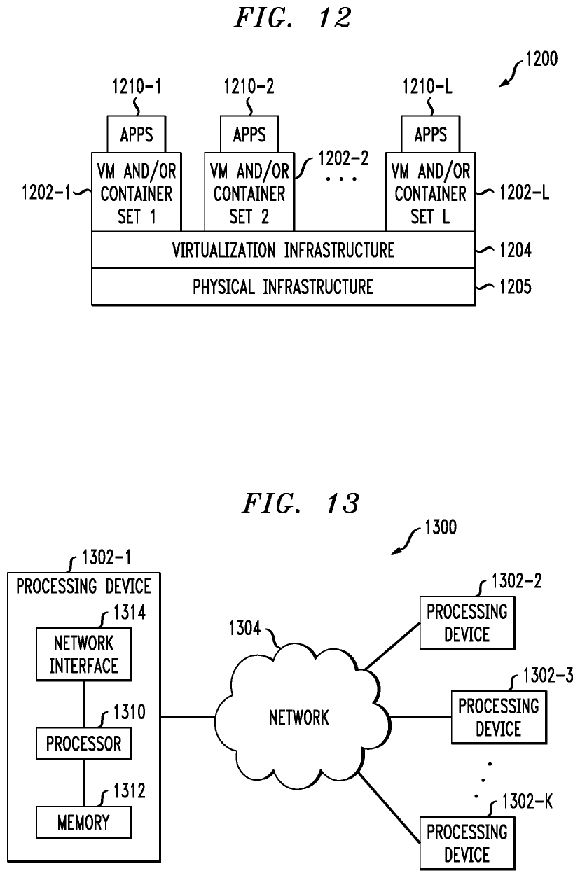

Illustrative embodiments of processing platforms will now be described in greater detail with reference to FIGS. 12 and 13. Although described in the context of system 100, these platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that are utilized to implement at least a portion of the information processing system 100. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 comprise respective VMs, respective sets of one or more containers, or respective sets of one or more containers running in VMs. In some implementations of the FIG. 12 embodiment, the VMs/container sets 1202 comprise respective VMs implemented using virtualization infrastructure 1204 that comprises at least one hypervisor.

A hypervisor platform may be used to implement a hypervisor within the virtualization infrastructure 1204, wherein the hypervisor platform has an associated virtual infrastructure management system. The underlying physical machines comprise one or more information processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises a portion of system 100 and includes a plurality of processing devices, denoted 1302-1, 1302-2, 1302-3, . . . 1302-K, which communicate with one another over a network 1304.

The network 1304 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1302-1 in the processing platform 1300 comprises a processor 1310 coupled to a memory 1312.

The processor 1310 comprises a microprocessor, a CPU, a GPU, a TPU, a microcontroller, an ASIC, a FPGA or other type of processing circuitry, as well as portions or combinations of such circuitry elements.

The memory 1312 comprises random access memory (RAM), read-only memory (ROM) or other types of memory, in any combination. The memory 1312 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data pertaining to a request from a user for at least one device;
predicting labeling information for the at least one device by processing at least a portion of the obtained data using one or more artificial intelligence techniques;
generating, based at least in part on the predicted labeling information, at least one image of at least one label to be applied to the at least one device; and
performing one or more automated actions based at least in part on the at least one generated image of the at least one label;
wherein the method is performed by at least one processing device comprising a processor coupled to a memory.

2. The computer-implemented method of claim 1, wherein processing at least a portion of the obtained data using one or more artificial intelligence techniques comprises processing the at least a portion of the obtained data using at least one ensemble boosting-based multi-output classifier.

3. The computer-implemented method of claim 2, wherein processing the at least a portion of the obtained data using at least one ensemble boosting-based multi-output classifier comprises using one or more of at least one gradient boosting classifier and at least one extreme gradient boosting classifier.

4. The computer-implemented method of claim 1, wherein processing at least a portion of the obtained data using one or more artificial intelligence techniques comprises processing the at least a portion of the obtained data using one or more shallow learning algorithms comprising at least one of one or more ensemble decision tree bagging and boosting techniques, at least one k-nearest neighbors (K-NN) algorithm, and one or more support vector machines (SVMs).

5. The computer-implemented method of claim 1, wherein generating the at least one image of the at least one label comprises inserting one or more items of content, corresponding to at least a portion of the predicted labeling information, into one or more portions of at least one device label template selected in accordance with at least one of the predicted labeling information and the obtained data.

6. The computer-implemented method of claim 1, wherein generating the at least one image of at least one label to be applied to the at least one device comprises generating the at least one image of at least one label to be applied to at least one of a device component of the at least one device and a packaging component associated with the at least one device.

7. The computer-implemented method of claim 1, wherein performing one or more automated actions comprises automatically generating at least one device label, in accordance with the at least one generated image, to be applied to the at least one device in connection with the request from the user.

8. The computer-implemented method of claim 7, wherein generating at least one device label comprises generating the at least one device label upon obtaining approval by the user of the at least one generated image.

9. The computer-implemented method of claim 1, wherein performing one or more automated actions comprises automatically outputting, to the user for approval, one or more of the predicted labeling information and the at least one generated image.

10. The computer-implemented method of claim 1, wherein performing one or more automated actions comprises automatically training at least a portion of the one or more artificial intelligence techniques using at least the at least one generated image of the at least one label.

11. The computer-implemented method of claim 1, wherein obtaining data pertaining to the request from the user for the at least one device comprises obtaining information pertaining to at least one of an order by the user for the at least one device and shipping instructions for the at least one device to the user.

12. The computer-implemented method of claim 1, further comprising:
training the one or more artificial intelligence techniques using multi-dimensional features derived from historical device labeling information across multiple users and multiple devices.

13. A non-transitory processor-readable storage medium having stored therein program code of one or more software programs, wherein the program code when executed by at least one processing device causes the at least one processing device:
to obtain data pertaining to a request from a user for at least one device;
to predict labeling information for the at least one device by processing at least a portion of the obtained data using one or more artificial intelligence techniques;
to generate, based at least in part on the predicted labeling information, at least one image of at least one label to be applied to the at least one device; and
to perform one or more automated actions based at least in part on the at least one generated image of the at least one label.

14. The non-transitory processor-readable storage medium of claim 13, wherein processing at least a portion of the obtained data using one or more artificial intelligence techniques comprises processing the at least a portion of the obtained data using at least one ensemble boosting-based multi-output classifier.

15. The non-transitory processor-readable storage medium of claim 13, wherein generating the at least one image of the at least one label comprises inserting one or more items of content, corresponding to at least a portion of the predicted labeling information, into one or more portions of at least one device label template selected in accordance with at least one of the predicted labeling information and the obtained data.

16. The non-transitory processor-readable storage medium of claim 13, wherein performing one or more automated actions comprises automatically generating at least one device label, in accordance with the at least one generated image, to be applied to the at least one device in connection with the request from the user.

17. An apparatus comprising:
at least one processing device comprising a processor coupled to a memory;
the at least one processing device being configured:
to obtain data pertaining to a request from a user for at least one device;
to predict labeling information for the at least one device by processing at least a portion of the obtained data using one or more artificial intelligence techniques;
to generate, based at least in part on the predicted labeling information, at least one image of at least one label to be applied to the at least one device; and
to perform one or more automated actions based at least in part on the at least one generated image of the at least one label.

18. The apparatus of claim 17, wherein processing at least a portion of the obtained data using one or more artificial intelligence techniques comprises processing the at least a portion of the obtained data using at least one ensemble boosting-based multi-output classifier.

19. The apparatus of claim 17, wherein generating the at least one image of the at least one label comprises inserting one or more items of content, corresponding to at least a portion of the predicted labeling information, into one or more portions of at least one device label template selected in accordance with at least one of the predicted labeling information and the obtained data.

20. The apparatus of claim 17, wherein performing one or more automated actions comprises automatically generating at least one device label, in accordance with the at least one generated image, to be applied to the at least one device in connection with the request from the user.
